(19) United States
(12) Patent Application Publication
(10) Pub. No.: US 2021/0178609 A1
(43) Pub. Date: Jun. 17, 2021

(54) Gripping Device for Use with a Robot

(71) Applicant: ATI Industrial Automation, Inc., Apex, NC (US)

(72) Inventor: Daniel Allen Norton, Apex, NC (US)

(21) Appl. No.: 16/710,170

(22) Filed: Dec. 11, 2019

(51) Int. Cl. B25J 15/08; B25J 15/06; B25J 15/00

(52) U.S. Cl. CPC B25J 15/086; B25J 9/1602; B25J 15/0033; B25J 15/0658

(57) ABSTRACT

A gripping device to grip and provide one or more utilities to a tool. The gripping device includes a body and fingers. One or more of the fingers are movable relative to the body for the gripping device to be movable between an open orientation and a closed orientation. In the open orientation, the fingers are spaced apart to be positioned on opposing sides of the tool. In the closed orientation, the fingers are movable to grip the tool. One or more of the fingers include utility connectors that extend through the finger. The utility connectors supply one or more utilities to the tool to operate the tool while being gripped by the fingers.

### FIELD OF INVENTION

The present invention relates generally to gripping devices configured to grip a tool and, more specifically, to gripping devices that supply one or more utilities to a tool that is being gripped.

### BACKGROUND

In many robotic manufacturing applications, it is cost-effective to utilize a robot, such as a generic robot arm, to accomplish a variety of tasks. For example, in an automotive manufacturing application, a robot may be utilized to cut, grind, or otherwise transfer parts during one phase of production, and perform a variety of welding tasks in another. Different welding tool geometries may be advantageously mated to a particular robot arm to perform welding tasks at different locations or in different orientations.

In these applications, a robotic tool changer is used to mate different robotic tools to the robot. One half of the tool changer, called the master unit, is permanently affixed to a robot arm. The other half, called the tool unit, is affixed to each robotic tool that the robot may utilize. The various robotic tools a robot may utilize are typically stored, within the range of motion of the robot arm, in tool stands which are sized and shaped to hold each tool securely when not in use. When the robot positions the master unit, on the end of the robot arm, adjacent to a tool unit connected to a desired robotic tool sitting in a tool stand, a coupling mechanism is actuated that mechanically locks the master and tool units together, thus affixing the robotic tool to the end of the robot arm. The tool changer thus provides a consistent mechanical interface between a robot arm and a variety of robotic tools. A tool changer may also pass utilities to a robotic tool. The tool changer can also provide utilities, such as electrical current, air pressure, hydraulic fluid, cooling water, electronic or optical data signals, and the like, to the attached tools for operation.

One type of robotic tool used with a robot is a gripping device that includes fingers that are movable between open and closed positions to grip a tool. Current operations are inefficient when using the gripping device with a tool changer because the operations require an excess amount of movement of the robot as well as excessive engagements and disengagements of tools from the robot. Options for reducing the inefficiencies are difficult because of the need to pass utilities to the attached tools to provide for operation of the tools.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

One aspect is directed to a gripping device for use with a robot to use a tool. The gripping device comprises a body configured to be connected to the robot, a grip comprising a plurality of fingers that extend from the body with the grip movable between an open orientation with the plurality of fingers being spaced a first distance apart and a closed orientation with the plurality of fingers being spaced a smaller second distance apart to grasp the tool, and one or more utility connectors that extend through one or more of the fingers and to provide one or more utilities to the tool when the grip is in the closed orientation.

In another aspect, each of the plurality of fingers is movable relative to the body.

In another aspect, one or more of the plurality of fingers is movable relative to the body and one or more of the plurality of fingers are stationary relative to the body.

In another aspect, each of the fingers comprises at least one utility connector.

In another aspect, each of one or more utility connectors comprises an indent on an inner surface of the finger to receive a protrusion on the tool, and a connection valve on an outer surface of the finger to connect to a utility line.

In another aspect, one or more alignment protrusions extend outward from the fingers to contact against and align the tool relative to the plurality of fingers.

In another aspect, one or more of the fingers comprise a fluid channel that extends through an interior of the finger and is spaced away from the one or more utility connectors.

In another aspect, a control unit with a processing circuit is configured to control the position of the plurality of fingers and to control a supply of the one or more utilities that are supplied to the tool through the one or more utility connectors.

In another aspect, a first one of the utility connectors supplies electricity to the tool and a second one of the utility connectors supplies hydraulic fluid to the tool.

One aspect is directed to a gripping device for use with a robot to use a tool. The gripping device comprises a body, a plurality of fingers that extend from the body with each of the fingers comprising an inner side and an outer side, and one or more utility connectors on one or more of the plurality of fingers. Each of the utility connectors comprises a channel that extends through the finger with a first end at the inner side of the finger and an second end at the outer side of the finger, a port at the first end of the channel to engage with the tool, and a connection member at the second end to connect to a utility line that supplies a utility. The plurality of fingers forming a grip that is adjustable between an open orientation with the plurality of fingers spaced apart by a first distance and a closed orientation with the plurality of fingers in closer proximity than the first distance to grip the tool.

In another aspect, each of the fingers comprises at least one utility connector.

In another aspect, at least two of the fingers comprise a first utility connector to supply a first utility to the tool and a second utility to supply a different second utility to the tool.

In another aspect, at least one of the fingers comprises one or more fluid channels that extend through the finger with each of the fluid channels comprising an inlet and an outlet on the finger and are spaced away from the one or more utility connectors.

In another aspect, two or more of the channels extend through at least one of the fingers with the two or more channels being spaced apart within the interior of the fingers.

One aspect is directed to a method of gripping a tool. The method comprises: positioning fingers on opposing sides of the tool with the fingers being connected to a robot; closing the fingers and gripping the tool with the fingers; engaging one or more utility connectors on one of more of the fingers with corresponding receptacles on the tool; while the fingers are closed on the tool, moving one or more utilities to the tool through the one or more utility connectors in the one or more fingers; and operating the tool while the fingers are gripping the tool and the one or more utilities are being supplied to the tool through the one or more utility connectors.

In another aspect, the method comprises moving the fingers away from the tool and disengaging the one or more utility connectors from the corresponding receptacles and preventing the one or more utilities from being supplied to the tool.

In another aspect, the method comprises supplying a first utility and a second utility to the tool through two or more of the fingers.

In another aspect, the method comprises supplying a fluid to one or more channels in the fingers and dispensing the fluid onto an item that is being acted on by the tool.

In another aspect, closing the fingers and gripping the tool with the fingers comprises one or more of the fingers remaining stationary while one or more of the fingers moves together.

In another aspect, moving the one or more utilities to the tool through the one or more utility connectors in the one or more fingers comprises moving hydraulic fluid through the one or more utility connectors.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. Accordingly, terms of reference such as up, down, left, right, vertical, horizontal, and the like, which are used herein for clarity of expression, apply only to the orientation of elements in the drawings and are hence relative, and not absolute, directions. Naturally, in use, the elements depicted in the drawings may assume any orientation or be viewed from a different perspective.

FIG. 1 is a perspective view of a gripping device with fingers in an open orientation on opposing sides of a tool.

FIG. 2 is a schematic side view of a gripping device mounted to a robot.

FIG. 3 is a schematic side view of a gripping device with a pivoting finger and a fixed finger.

FIG. 4A is a bottom schematic view of ends of fingers of a gripping device in an open orientation.

FIG. 4B is a bottom schematic view of the gripping device of FIG. 4A in a closed orientation.

FIG. 5A is a bottom schematic view of ends of fingers of a gripping device in an open orientation.

FIG. 5B is a bottom schematic view of the gripping device of FIG. 5A in a closed orientation.

FIG. 6 is a perspective view of a gripping device.

FIG. 7 is a perspective view of a gripping device.

FIG. 8 is a side schematic view of a finger with channels extending through an interior of the finger to supply one or more utilities.

FIG. 9 is an exploded perspective view of a tool positioned between fingers of a gripping device with the fingers in an open orientation.

FIG. 10 is a perspective view of a tool for use with a gripping device.

FIG. 11 is a flowchart diagram of a method of using a gripping device.

FIG. 12 is a side view of fluid lines that extend through fingers of a gripping device to supply a fluid to an item that is secured in a tool.

FIG. 13 is a side view of fluid lines that extend through fingers of a tool to supply a fluid to an item that is secured in the tool.

FIG. 14 is a schematic diagram of a control unit that controls one or more of the gripping device and the robot.

FIG. 15 is a schematic diagram of a control unit.

### DETAILED DESCRIPTION

The present application is directed to a gripping device with fingers configured to grip a tool. The fingers are further equipped to supply one or more utilities to the tool while being gripped. The one or more utilities provide for the tool to operate while being gripped by the fingers.

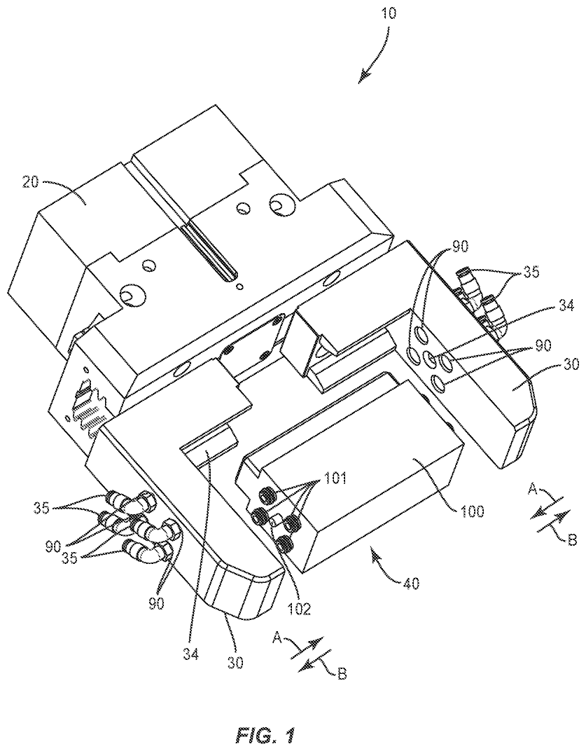

FIG. 1 illustrates a gripping device 10 that is positioned in proximity to a tool 100 (generically illustrated in FIG. 1). The gripping device 10 includes a body 20 and fingers 30. One or both of the fingers 30 are movable relative to the body 20 for the gripping device 10 to be movable between an open orientation (as illustrated in FIG. 1) and a closed orientation. In the open orientation, the fingers 30 are spaced apart to be positioned on opposing sides of the tool 100. In the closed orientation, the fingers 30 are moved inward to grip the tool 100. One or more of the fingers 30 include utility connectors 90. Each utility connector 90 includes a channel 60 that extends through the finger 30. Each utility connector 90 provides for transferring a utility through the finger 30 and to the tool 100 to operate the tool 100 while being gripped by the fingers 30. The number of utility connectors 90 that extend through each finger 30 can vary between none to three or more.

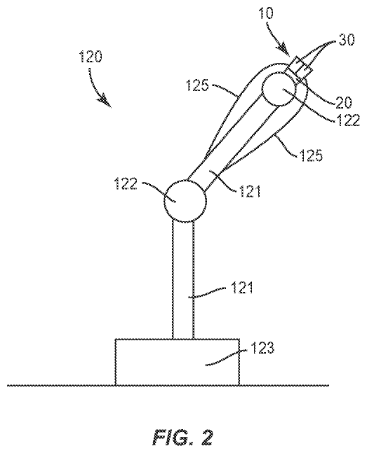

The gripping device 10 is configured to be connected to and operated by a robot 120. The gripping device 10 can be used with a wide variety of robots 120 that provide for attachment, movement, and operation. The robots 120 can provide a variety of different movements and positions for the gripping device 10 to perform the specific tasks. FIG. 2 illustrates one example of a robot 120 configured to operate and move the gripping device 10 to perform various functions. The robot 120 can include one or more arms 121 that are movably connected together at joints 122. The robot 120 can also include a base 123 that can be fixed to a support floor, or can be movable about the support floor.

One or more utility lines 125 extend from the robot 120 and into the gripping device 10 to supply one or more utilities that are transferred to the tool 100. FIG. 2 schematically illustrates a pair of utility lines 125 positioned on the exterior of the outer-most arm 121 and connected to the gripping device 10. Another example includes one or more of the utility lines 125 extending through the outer-most arm 121 and connecting to the body 20. The utility is then fed through the body 20 and into the one or more fingers 30. Another example includes the utility lines 125 being separate from the robot 120.

Returning to FIG. 1, the fingers 30 form a grip 40 that is adjustable to hold and release the tool 100. In an open orientation, the grip 40 is sized for the fingers 30 to be positioned on opposing sides the tool 100. In a closed orientation, the fingers 30 are in closer proximity to contact against and grip the tool 100.

In one example as illustrated in FIG. 1, each finger 30 is movable relative to the body 20 to adjust the grip 40 between the open and closed orientations. Each of the fingers 30 can include the same amount of movement. As illustrated in FIG. 1, each finger 30 moves the same amount in an inward direction indicated by arrows A and an outward direction indicated by arrows B.

In another example, a limited number of fingers 30 move relative to the body 20. FIG. 3 includes an example with the grip 40 formed by fingers 30a, 30b. FIG. 30a is integrally formed with the body 20 and does not move relative to the body 20. Finger 30b moves relative to the body 20 as illustrated by arrows A and B. In the open orientation, finger 30b is spaced a first distance away from finger 30a for the grip 40 to be sized to extend around an tool (not illustrated in FIG. 3). In the closed orientation, finger 30b moves inward in closer proximity to the finger 30a. One or more utility connectors 90 can extend through one or more of the fingers 30. In the example of FIG. 3, a single utility connector 90 extends through finger 30a.

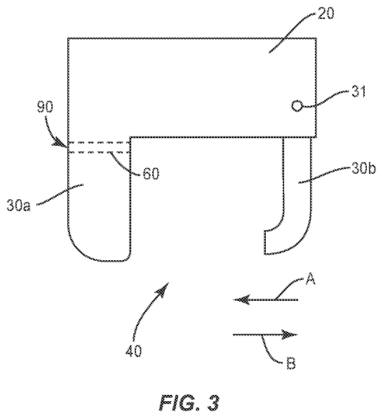

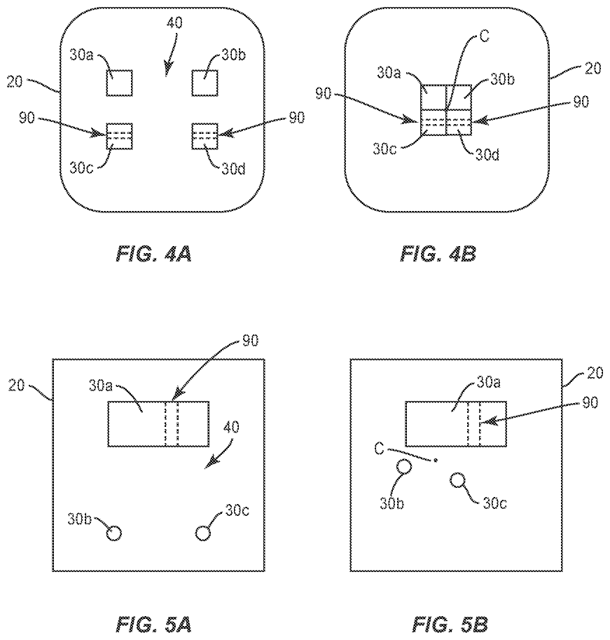

FIG. 4A illustrates a schematic end view of the fingers 30 spaced apart in an open orientation. FIG. 4B illustrates the fingers 30 in a closed orientation with each of the fingers 30 having moved inward. In the various examples, the fingers 30 can be in contact in the closed orientation when no tool is positioned within the grip 40. In another example, one or more of the fingers 30 are spaced away from other fingers 30 in the closed orientation. In this example, the fingers 30 are in close enough proximity to grip the tool 100. Again, one or more of the fingers 30 can include one or more utility connectors 90.

FIG. 5A illustrates a schematic end view of a grip 40 formed by fingers 30a, 30b, 30c. Finger 30a is larger than either of fingers 30b or 30c. FIG. 5B illustrates a closed orientation. In this example, finger 30a remains relatively stationary and does not move relative to the body 20. Both fingers 30b and 30c move relative to the body 20 between the open and closed orientations. Finger 30b moves a greater amount than finger 30c. One or more of the fingers 30 can include one or more utility connectors 90.

In one example as illustrated in FIG. 4B, the fingers 30 are positioned at a center C of the body 20 in the closed orientation. In another example as illustrated in FIG. 5B, the fingers 30 are offset from a center C of the body 20 in the closed orientation.

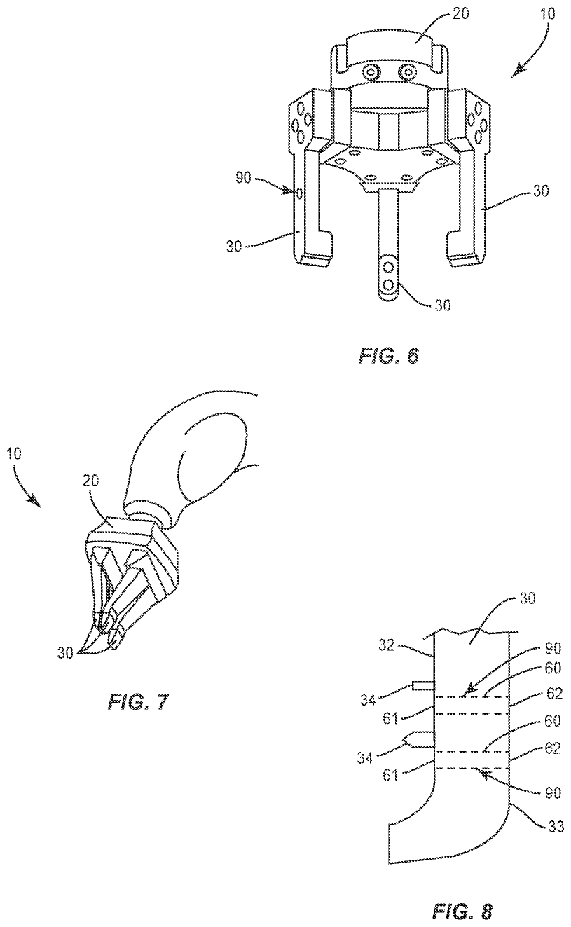

The fingers 30 can move relative to the body 20 in a variety of different manners. FIG. 1 includes an example in which the fingers 30 are positioned on a track on the body 20. The fingers 30 move along the track when moving in the direction of arrows A and B. FIG. 3 includes an example in which finger 30b is attached to the body 20 at a pivot 31. The finger 30b moves about pivot 31 when moving in the direction of arrows A and B. FIGS. 6 and 7 illustrate gripping devices 10 with fingers 30 pivotally attached to the body 20. In the various examples, each of the fingers 30 can move independently from the other fingers. In another example, two or more of the fingers 30 are connected together and move as a single unit.

The fingers 30 can be powered in different manners. In one example, gears in the body 20 are rotated to cause movement of the fingers 30. In another example, the fingers 30 are powered by pneumatic or electrical actuators to move between the open and closed orientations. Each of the fingers 30 can be powered in the same manner, or two or more of the fingers 30 can be powered in different manners.

The fingers 30 are further configured to supply one or more utilities to a gripped tool 100. The utilities are supplied through the one or more utility connectors 90 with the one or more channels 60 that extend through the fingers 30. FIG. 8 illustrates a finger 30 with a utility connectors 90 with two channels 60. Each channel 60 extends through the finger 30 and includes a first end 61 at an inner side 32 of the finger 30 and a second end 62 at an outer side 33 of the finger 30. The first end 61 is configured to engage with a corresponding receptacle 101 in the tool 100. The second end 62 is configured to engage with the one of the utility lines 125 that feed the utility. One or both of the ends 61, 62 can include projections, indentations, fittings, or other structure to facilitate the engagement with the respective element. FIG. 1 illustrates fittings 35 mounted to the second ends 62 of the channels 60 to engage with the utility lines 125 (not illustrated in FIG. 1).

One or more alignment features 34 positioned on the inner side 32 of the fingers 30 engage with corresponding alignment features 102 on the tool 100. The alignment features 34, 102 can include various complementary projections and receptacles that engage together when the fingers 30 grip the tool 100.

One or more alignment members 34 are positioned to contact against and position the tool 100 between the fingers 30 in the open configuration. As illustrated in FIG. 1, the alignment members 34 can control an extent to which the tool 100 is positioned towards the body 20. One or more alignment members 34 can also control the lateral position of the tool 100 relative to the fingers 30. The alignment members 34 include one or more contact surfaces that contact against the tool 100 when the fingers 30 are in the closed orientation. The alignment members 34 can be attached to and movable with the fingers 30. In another example, the alignment members 34 are attached to the body 20 and are stationary relative to the fingers 30.

The tool 100 can include various devices that require one or more utilities to operate. Examples include but are not limited to drills, saws, gripping devices, and grinders. The tools 100 can require one or more utilities, such as electrical current, air pressure, hydraulic fluid, cooling water, electronic or optical data signals, and the like, for operation.

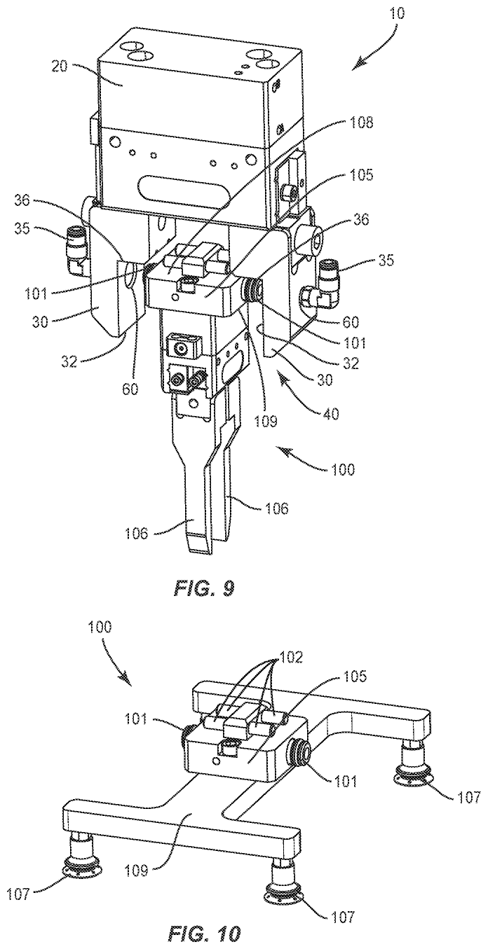

FIG. 9 illustrates a gripping tool 100. The tool 100 includes a body 105 with movable fingers 106. The body 105 includes a pair of receptacles 101 each configured to engage with a channel 60 in one of the fingers 30. The shape of the body 105 complements the fingers 30 to facilitate alignment and gripping of the tool 100. This can include a planar top surface 108 that contacts against a planar shelf 36 of the fingers 30 with the shelf 36 acting as an alignment feature. The body 105 also includes a planar outer surface 109 that contacts against a planar inner side 32 of the fingers 30.

Fingers 106 are connected to the body 105. One or more of the fingers 106 are movable relative to the body 105 to move between open and closed positions to grip an item. The fingers 106 can have various numbers and movements the same as those stated above for fingers 30. In one example, the gripping tool 100 provides for effectively gripping and moving smaller items than the fingers 30. In another example, fingers 106 may provide lesser holding force to the item which facilitates movement of fragile items 200 (e.g., produce, electrical circuitry).

FIG. 10 illustrates a suction tool 100 configured to supply a suction force to an item. The suction tool 100 includes a body 105 with receptacles 101 configured to engage with channels 60 in the fingers 30. A frame 109 is attached to the body 105 and includes suction cups 107 on the outer reaches. Suction force is provided through the channels 60 in the fingers 30 to provide a force to secure an item that is contacted against one of more of the suction cups 107. Alignment features 102 include cylindrical extensions that extend outward and make within corresponding circular receptacles in the fingers 30.

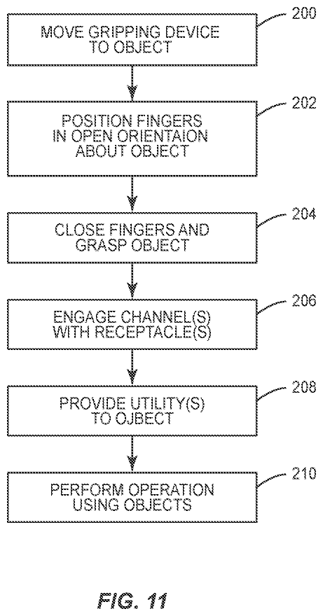

FIG. 11 illustrates one method of using the gripping device 10. The gripping device 10 is attached to a robot 120 and moved to a tool 100 (block 200). The gripping device 10 is adjusted with the fingers 30 in the open orientation and placed on opposing sides of the tool 100 (block 202). The fingers 30 are then moved towards the closed orientation to contact against and grip the tool 100 (block 204). This movement of the fingers 30 further aligns the one or more channels 60 of the one or more utility connectors 90 that extend through one or more of the fingers 30 with the one or more receptacles 101 of the tool 100 (block 206). Once the channels 60 are engaged with the receptacles 101, the one or more utilities can be passed between the fingers 30 and tool 100 and one or more utility lines 125 (block 208). The one or more utilities provide for the tool 100 to operate. While operating, the robot 120 moves the tool 100 to the desired location for the tool 100 to perform the operation (block 210).

The one or more utilities provided to the tool 100 can be the same as those required to operate the robot 120. In another example, one or more of the utilities provided to the tool 100 are different than those required to operate the robot 120.

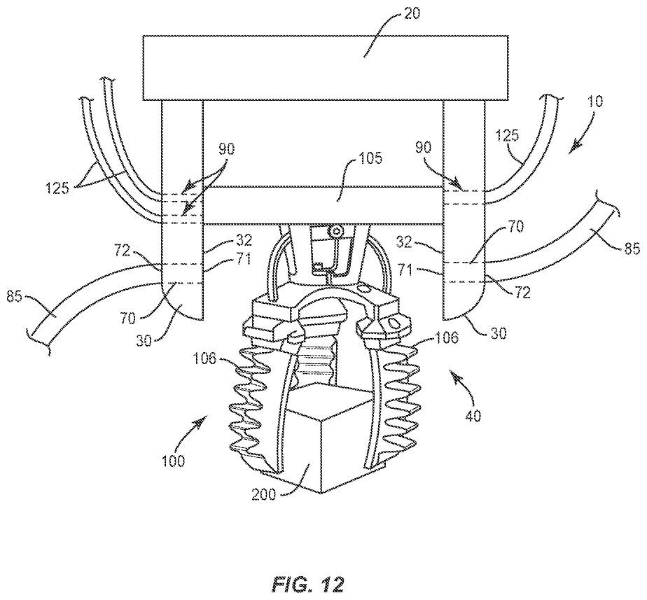

The gripping device 10 is also configured to supply a fluid to an item 200 that is held by the tool 10. As illustrated in FIG. 12, one or more channels 70 extend through one or more of the fingers 30 of the gripping device 10. The channels 70 are spaced away from the utility connectors 90. The channels 70 each include an inlet 72 that engage with an input line 85 that feeds the fluid. Each channel 70 further includes an outlet 71 at the inner side of the finger 30. The channel 70 is positioned for the fluid to flow from the outlet 71 and onto an item 200 at the tool 100. The example of FIG. 12 includes the fluid being directed on the item 200 as it is being gripped by a gripping device tool 100. Nozzles can be attached at the outlets 71 to direct the fluid.

The fluid is directed to the item 200 and does not pass through or into the tool 100 that is being gripped by the gripping device 10. This configuration provides for the fluid to contact the item 200 while it is being gripped or otherwise treated by the tool 100. This prevents the gripping device 10 having to move the item 200 to a separate location for treatment. For example, this prevents having to transport the item 200 to a wash facility. The input lines 85 can extend from the robot 120, or can be separate from the robot 120. Various fluids can be used within this configuration, including but not limited to water, air, cleaning solution, paint, and sealant.

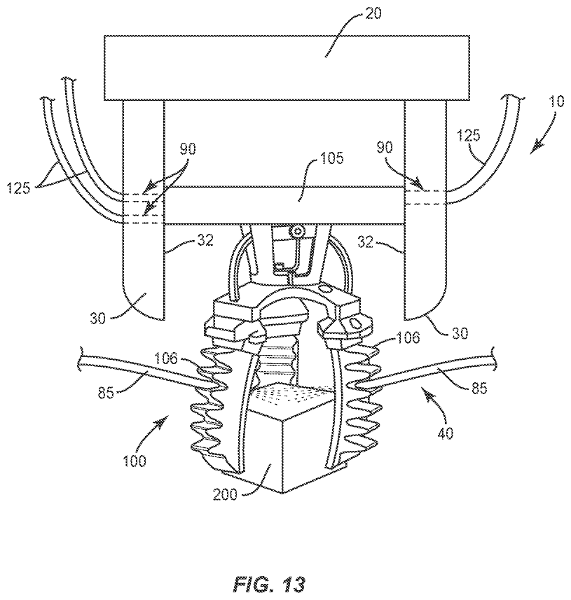

FIG. 13 includes an example with the input lines 85 connecting directly to one or more of the fingers 106 of the tool 100. Fluid that passes through the input lines 85 is directed from the inner side of the fingers 106 onto the item 200. This provides for the item 200 to be washed or otherwise wetted while being held by the fingers 106.

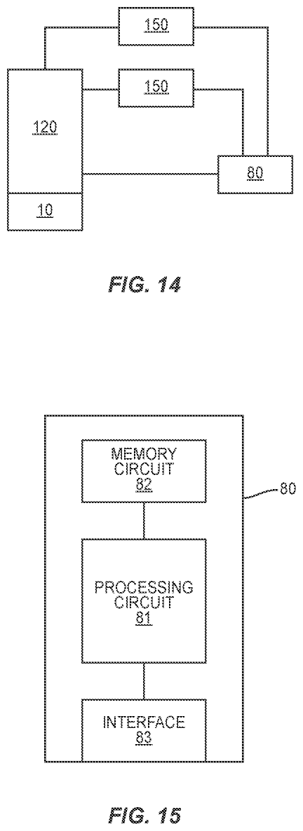

As illustrated in FIG. 14, a control unit 80 can oversee the operation of one or more of the gripping device 10 and robot 120. The control unit 40 can signal control steps to one or more of the gripping device 10, robot 120, and utility sources 150. FIG. 14 illustrates the control unit 80 providing control for each of these components. Other examples can include the control unit 80 providing control for just the robot 120, which in turn operates the gripping device 10 and provides for the one or more utilities from the utility sources 150. The control unit 80 can be located at various locations, including remotely from these components, incorporated into the robot 120, and incorporated into the gripping device 10.

As illustrated in FIG. 15, the control unit 80 includes one or more processing circuits (shown as processing circuit 81) that can include one or more microprocessors, Application Specific Integrated Circuits (ASICs), or the like, configured with appropriate software and/or firmware. A computer readable storage medium (shown as memory circuit 82) stores data and computer readable program code that configures the processing circuit 81 to implement the techniques described above. Memory circuit 82 is a non-transitory computer readable medium, and can include various memory devices such as random access memory, read-only memory, and flash memory. An interface 83 is configured to communicate with the components. In one embodiment the interface 83 includes a transceiver configured to wirelessly communicate with the components. The interface 83 can also provide for hardwire connection with the components. The system interface 83 can also provide for the supply of power from a remote source.

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A gripping device for use with a robot to use a tool, the gripping device comprising:
a body configured to be connected to the robot;
a grip comprising a plurality of fingers that extend from the body, the grip movable between an open orientation with the plurality of fingers being spaced a first distance apart and a closed orientation with the plurality of fingers being spaced a smaller second distance apart to grasp the tool; and
one or more utility connectors that extend through one or more of the fingers and to provide one or more utilities to the tool when the grip is in the closed orientation.

2. The gripping device of claim 1, wherein each of the plurality of fingers is movable relative to the body.

3. The gripping device of claim 1, wherein one or more of the plurality of fingers is movable relative to the body and one or more of the plurality of fingers are stationary relative to the body.

4. The gripping device of claim 3, wherein each of the fingers comprises at least one utility connector.

5. The gripping device of claim 1, wherein each of one or more utility connectors comprises an indent on an inner surface of the finger to receive a protrusion on the tool, and a connection valve on an outer surface of the finger to connect to a utility line.

6. The gripping device of claim 1, further comprising one or more alignment protrusions that extend outward from the fingers to contact against and align the tool relative to the plurality of fingers.

7. The gripping device of claim 1, wherein one or more of the fingers comprise a fluid channel that extends through an interior of the finger and is spaced away from the one or more utility connectors.

8. The gripping device of claim 1, further comprising a control unit with a processing circuit configured to control the position of the plurality of fingers and to control a supply of the one or more utilities that are supplied to the tool through the one or more utility connectors.

9. The gripping device of claim 1, wherein a first one of the utility connectors supplies electricity to the tool and a second one of the utility connectors supplies hydraulic fluid to the tool.

10. A gripping device for use with a robot to use a tool, the gripping device comprising:
a body;
a plurality of fingers that extend from the body, each of the fingers comprising an inner side and an outer side; and
one or more utility connectors on one or more of the plurality of fingers, each of the utility connectors comprising:
a channel that extends through the finger with a first end at the inner side of the finger and an second end at the outer side of the finger;
a port at the first end of the channel to engage with the tool; and
a connection member at the second end to connect to a utility line that supplies a utility;
the plurality of fingers forming a grip that is adjustable between an open orientation with the plurality of fingers spaced apart by a first distance and a closed orientation with the plurality of fingers in closer proximity than the first distance to grip the tool.

11. The gripping device of claim 10, wherein each of the fingers comprises at least one utility connector.

12. The gripping device of claim 10, wherein at least two of the fingers comprise a first utility connector to supply a first utility to the tool and a second utility to supply a different second utility to the tool.

13. The gripping device of claim 10, wherein at least one of the fingers comprises one or more fluid channels that extend through the finger, each of the fluid channels comprising an inlet and an outlet on the finger and are spaced away from the one or more utility connectors.

14. The gripping device of claim 10, wherein two or more of the channels extend through at least one of the fingers with the two or more channels being spaced apart within the interior of the fingers.

15. A method of gripping a tool, the method comprising:
positioning fingers on opposing sides of the tool with the fingers being connected to a robot;
closing the fingers and gripping the tool with the fingers;
engaging one or more utility connectors on one of more of the fingers with corresponding receptacles on the tool;
while the fingers are closed on the tool, moving one or more utilities to the tool through the one or more utility connectors in the one or more fingers; and
operating the tool while the fingers are gripping the tool and the one or more utilities are being supplied to the tool through the one or more utility connectors.

16. The method of claim 15, further comprising moving the fingers away from the tool and disengaging the one or more utility connectors from the corresponding receptacles and preventing the one or more utilities from being supplied to the tool.

17. The method of claim 15, further comprising supplying a first utility and a second utility to the tool through two or more of the fingers.

18. The method of claim 15, further comprising supplying a fluid to one or more channels in the fingers and dispensing the fluid onto an item that is being acted on by the tool.

19. The method of claim 15, wherein closing the fingers and gripping the tool with the fingers comprises one or more of the fingers remaining stationary while one or more of the fingers moves together.

20. The method of claim 15, wherein moving the one or more utilities to the tool through the one or more utility connectors in the one or more fingers comprises moving hydraulic fluid through the one or more utility connectors.
